(19) United States
(12) Patent Application Publication
(10) Pub. No.: US 2002/0162257 A1
(43) Pub. Date: Nov. 7, 2002

(54) Landscape album page

(76) Inventor: Gerald Aubut, Boucherville (CA)

Correspondence Address: Mr. Alain M. Leclerc, c/o Goudreau Gage Dubuc, Stock Exchange Tower, 800 Place Victoria, Suite 3400, Montreal, Quebec, H4Z 1E9, CA

(21) Appl. No.: 09/848,299

(22) Filed: May 4, 2001

(51) Int. Cl. G09F 19/00

(52) U.S. Cl. 40/530

(57) ABSTRACT

Disclosed herein is a page for displaying inserts, such as photos. The page comprises a backing sheet, a clear display sheet and at least one horizontal row of pockets for receiving the inserts. The clear display sheet overlays at least one side of the backing sheet and is attached thereto about the backing sheet peripheral edge and along predetermined attachment patterns. The clear display sheet includes at least first and second openings, such as slits. The attachment patterns and the openings define a row of pockets. Two adjacent pockets of a given row share one of either first and second openings. A row of pockets may be used to display inserts, such as landscape photos, which span at least two adjacent pockets of this row. Also disclosed is an album including such pages, and a similar page in which the backing sheet includes at least first and second openings.

### FIELD OF THE INVENTION

The present invention relates to a page for displaying inserts of various conventional sizes. More preferably, the present invention is concerned with an album page for displaying a landscape photograph of various sizes.

### BACKGROUND OF THE INVENTION

Pages for displaying inserts of various conventional sizes are well known in the art. Specifically, album pages for displaying both regular sized photos and landscape photos are also known in the art.

Most of these types of pages include a backing sheet overlaid by a clear display sheet attached thereto and having a slit opening to define two adjacent pockets sharing this slit opening. A smaller photo can be inserted in one pocket and a larger photo can inserted in this page to span the two adjacent pockets.

U.S. Pat. No. 4,447,973 issued to Wihlke on May 15, 1984 discloses an album leaf comprising at least two superimposed and attached layers of especially plastic, including one layer of transparent plastic. The transparent layer has a cut line to define two adjacent pockets.

U.S. Pat. No. 6,135,663 issued to Tan on Oct. 24, 2000 discloses a photograph album page including a rectangular backing sheet. The backing sheet is overlaid by a transparent flexible plastic material. The overlaying material includes an central opening forming two adjacent pocket.

A drawback with such prior art album pages is that a larger photo such as a landscape photo which spans two adjacent pockets has to be bent in order to insert each lateral side into a respective pocket through the shared opening. The bending and difficult manipulation often damages the photograph and is generally troublesome.

### OBJECTS OF THE INVENTION

An object of the present invention is to provide an improved page for displaying inserts of various conventional sizes.

### SUMMARY OF THE INVENTION

More specifically, in accordance with the present invention, there is provided a page for displaying inserts of various conventional sizes, the page comprising:

a backing sheet defining a peripheral edge;

a clear display sheet overlaying at least one side of the backing sheet, the clear display sheet being attached to the backing sheet about the peripheral edge and along predetermined attachment patterns, the clear display sheet having at least first and second openings; and

at least one horizontal row of pockets for receiving the inserts, the row of pockets being defined by the attachment patterns and the openings, wherein two adjacent pockets of a given row share one of the first and second openings, and wherein during use, a row of pockets may be used to display inserts which span at least two adjacent pockets in this row.

In accordance with another aspect of the present invention, there is provided a page for displaying inserts of various conventional sizes, the page comprising:

a backing sheet defining a peripheral edge, the backing sheet having at least first and second openings;

a clear display sheet overlaying the backing sheet, the clear display sheet being attached to the backing sheet about the peripheral edge and along predetermined attachment patterns; and

at least one horizontal row of pockets for receiving the inserts, the row of pockets being defined by the attachment patterns and the openings, wherein two adjacent pockets of a given row share one of the first and second openings, and wherein during use, a row of pockets may be used to display inserts which span at least two adjacent pockets in this row.

In accordance with a further aspect of the present invention, there is provided a photo album including an album page for displaying inserts of various conventional sizes, the album page comprising:

a backing sheet defining a peripheral edge, the peripheral edge including an album securement portion;

a clear display sheet overlaying at least one side of the backing sheet, the clear display sheet being attached to the backing sheet about the peripheral edge and along predetermined attachment patterns, the clear display sheet having at least first and second openings; and

at least one horizontal row of pockets for receiving the inserts, the row of pockets being defined by the attachment patterns and the openings, wherein two adjacent pockets of a given row share one of the first and second openings, and wherein during use, a row of pockets may be used to display inserts which span at least two adjacent pockets in this row.

An advantage of the present invention is to provide a page for displaying inserts in which an insert, such as a landscape photo, may be inserted in a first pocket of a row through a first opening and then pushed into a second adjacent pocket of that given row through a second opening which is shared by these two adjacent pockets. Thus, facilitating insertion of the photograph and avoiding bending the landscape photo during insertion.

Other objects, advantages and features of the present invention will become more apparent upon reading of the following non restrictive description of preferred embodiments thereof, given by way of example only with reference to the accompanying drawings.

### BRIEF DESCRIPTION OF THE DRAWINGS

In the appended drawings, like reference numerals refer to like elements throughout and in which:

FIG. 1 is a front view of the page in accordance with a preferred embodiment of the present invention;

FIG. 2 is a perspective view of the page in accordance with another preferred embodiment of the present invention and of an album; and

FIG. 3 is a perspective view of the page and album of FIG. 2.

### DESCRIPTION OF THE PREFERRED EMBODIMENT

With reference to the drawings a preferred embodiment of the present invention will be herein described.

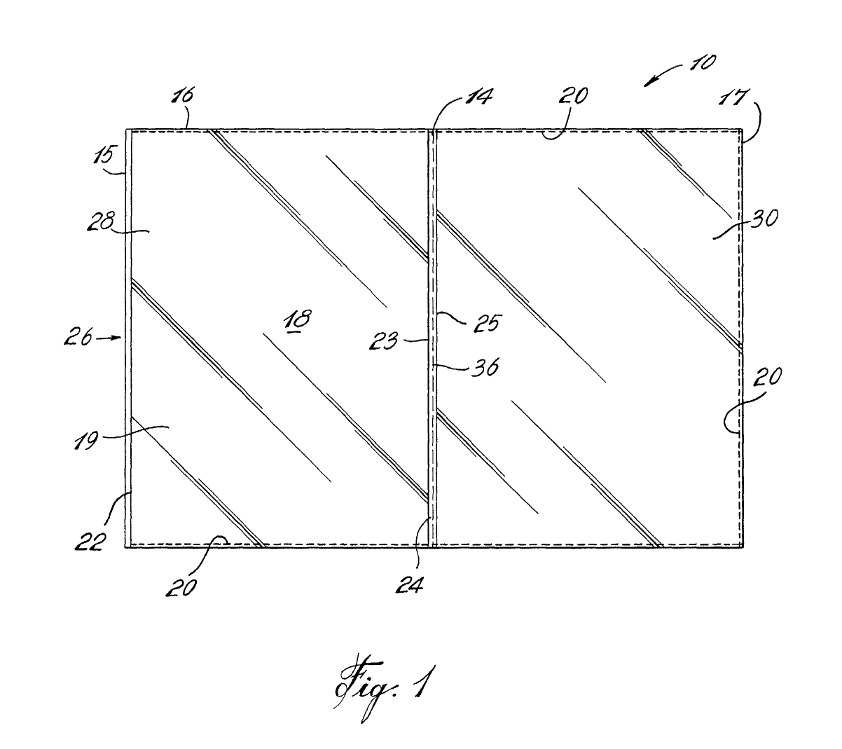

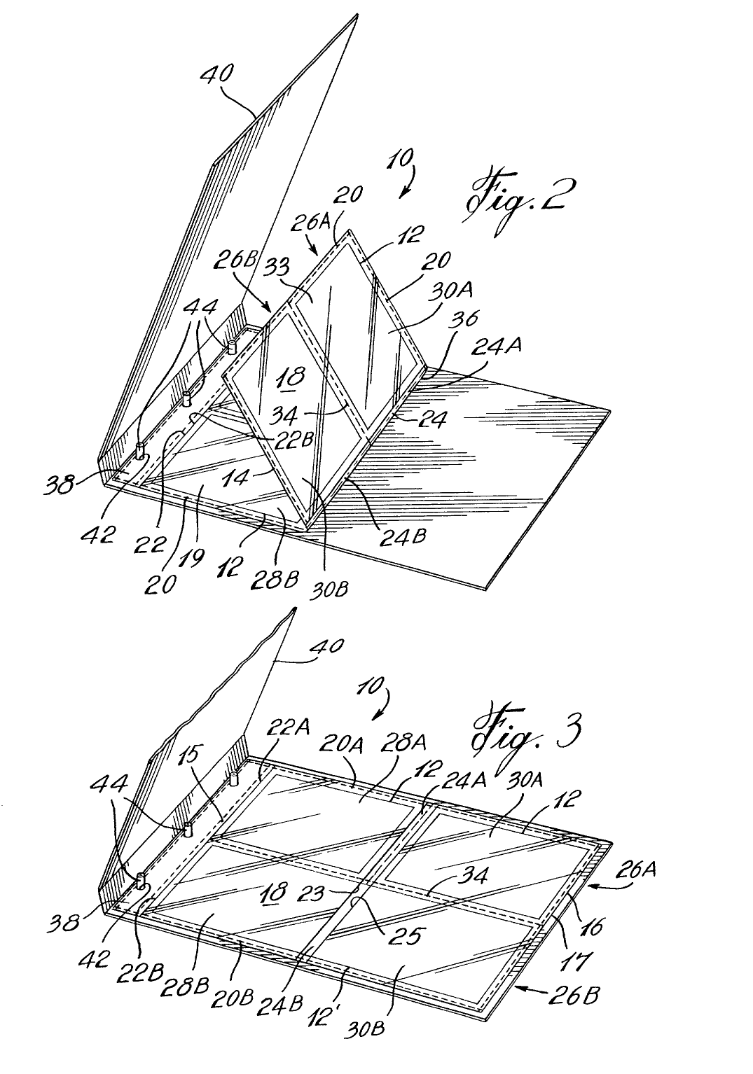

FIG. 1 shows one preferred embodiment of a page for displaying inserts 12 and 12′ (see FIGS. 2 and 3) of various conventional sizes. These inserts 12 and 12′ may be a variety of flat articles such as a photograph.

Page 10 includes a backing sheet 14 defining a peripheral edge 16 and a clear display sheet 18 overlaying at least one side 19 of the backing sheet 14. In the non-limiting example shown here, page 10 has a generally rectangular configuration yet, it is within the scope of the present invention to use a wide variety of suitable page configurations.

The clear display sheet 18 is attached to the backing sheet 14 about the peripheral edge 16 and along predetermined attachment patterns 20. This attachment may be on or near the peripheral edge 16, what is important is that the clear display sheet 18 spans a large portion of the backing sheet 14. The attachment patterns 20 may be seal lines, stitches or the like. The clear display sheet 14 also has first and second openings 22, 24. It must be noted that the terms “first” and “second” are used herein for convenience purposes only and hence, are interchangeable. Openings 22, 24 may be thin slits cut into the display sheet 18 or other larger cuts.

Preferably, the clear display sheet 18 is made of a transparent flexible plastic sheet material. Preferably, the backing sheet 14 is made of an opaque flexible plastic material that is thicker than the material used to make the clear display sheet. Alternatively, the backing sheet may also be made of the same transparent flexible plastic sheet material as the display sheet 18. In the foregoing case, the backing sheet may also act as a display sheet.

The attachment patterns 20 and the openings 22, 24 define a horizontal row 26 of pockets 28, 30 for receiving the inserts 12 or 12′.

As shown, the openings 22, 24 are spaced apart to define pockets wide enough to receive an insert 12 such as a conventional photo. Openings 22, 24 are also shown to be generally vertical, yet other suitable configurations can be contemplated within the scope of the invention; what is important is that openings 22, 24 are configured and sized to provide for an insert 12 to be easily inserted in a pocket 28, 30. The foregoing reasoning applies for the width of the cut in the display sheet 18 which forms an opening 22, 24. Obviously, the present page 10 may be provided with a greater number of openings which in turn define a greater number of pockets within a given horizontal row 26.

Any two adjacent pockets of a given row share one of these first and second openings 22, 24; in this example, pockets 28 and 30 share opening 24. This shared opening 24 defines two internal edges 23 and 25 in the clear display sheet 18.

With respect to the rectangular configuration of page 10 illustrated in the example of FIG. 1, the first opening 22 may either be formed at the left or right lateral sides 15 or 17 respectively of page 10. Alternatively, there may be two “first” openings 22 each at a respective lateral side 15 and 17.

As better shown in FIG. 2, a second clear display sheet 18, may overlay the other side 33 of the backing sheet 14. In this way, the page 10 may be a double sided display page having pockets 28, 30 on both its sides 19, 33 for displaying inserts 12.

In another preferred embodiment of page 10 shown in FIGS. 2 and 3, attachment patterns 20 may include a generally horizontal seal line 34 running across the clear display sheet 18 to define an upper row 26A of pockets 28A, 30A and a lower row 26B of pockets 28B, 30B. The seal line 34 also runs across the first opening 22 to form upper and lower first openings 22A, 22B and across the second opening 24 to form upper and lower second openings 24A, 24B. Adjacent pockets 28A, 30A of the upper row 26A share the upper second opening 24A. Adjacent pockets 28B, 30B of the lower row 26B share the lower second opening 24B. As shown, the seal line 34 is sufficiently spaced apart from the upper and lower attachment patterns 20A, 20B (see FIG. 3) respectively, to provide sufficient length for a standard photo insert 12.

It must be noted that the terms “upper” and “lower” are used herein only for convenience so as to distinguish between two horizontal rows 26 and hence are interchangeable. The terms “upper” and “lower” can also be omitted since what is true in accordance with the present invention for row 26 of FIG. 1 is also true for rows 26A and 26B of FIGS. 2 and 3 and vice versa.

Obviously, the attachment patterns 20 may include a plurality of generally horizontal seal lines 34 defining a plurality of rows 26. As aforementioned, each of these rows 26 may have a plurality of pockets 28, 30 with each two adjacent pockets 28, 30 in a row sharing an opening such as opening 24. Preferably, in such a case the length and width of page 10 would be sufficiently dimensioned so as to display a plurality of standard and larger photo inserts 12.

With reference to FIGS. 1 and 2, page 10 may also include a generally vertical fold line 36 so as to fold the page 10 in two. This fold line 36 is formed about an opening 24 for example, shared by two adjacent pockets 28, 30 of a given row 26. Of course, when a page 10 includes a row 26 with a plurality of pockets 28, 30, this page 10 may also include a plurality of fold lines 36 about each shared opening 24 to permit this page to be folded about each of these fold lines 36.

In another embodiment that is not shown but may be easily contemplated by the ordinarily skilled artisan from the present disclosure is a page 10 in which the backing sheet 14 has the first and second openings 22, 24. In such a case only one side 19, 33 of the backing sheet will be overlayed by the display sheet 18.

The present page 10 may be an album page and hence, include an album securement portion 38 for securing this album page 10 to an album 40. Album 40 may be provided in a variety of shapes and sizes that are suitable for including a variety of possible embodiments of album page 10 therein. The album securement portion 38 may include album ring receiving apertures 42 for receiving album rings 44 therethrough. It is within the scope of the present invention to use other types of ways known in the art of securing the album securement portion 38 to an album 40. In the example shown in FIGS. 2 and 3, the album securement portion 38 may be provided on either lateral side 15 or 17.

During use of the present page 10, pockets 28, 30 of a given row 26 may display respective inserts 12. The user may insert a standard insert 12 in a given pocket 28, 30 though either an opening 22 or 24 depending if this pocket is bounded by either one or both of these openings 22, 24. In this way, an album page 10 as configured in FIG. 2 may display four inserts in its pockets 28A (see FIG. 3), 30A, 28B and 30B on either or both its sides 19, 33.

Turning to figure, 3 a larger insert 12′, such as a landscape photo, which spans at least two pockets 28, 30 may also be displayed by page 10. This photo may be inserted into a pocket, such a first lower pocket 28B for example, through an opening, such as the first lower opening 22B which bounds this pocket 28B. The user will then push the insert 12′ through the shared opening, such as second lower opening 24B in this case, into the adjacent pocket, such as the second lower pocket 30B. In this way, the user may simply continuously slide the larger insert 12′ through two adjacent pockets sharing an opening avoiding bending this insert. Therefore, page 10 can display two inserts 12 in the upper row 26A and a larger insert 12′ spanning two pockets 28B, 30B in the lower row 26B.

Of course, when a given row 26 has a plurality of pockets 28, 30 with each two adjacent pockets sharing an opening 24 inserts spanning all the pockets in such a row may also be displayed.

It is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation. Hence, although the present invention has been described hereinabove by way of preferred embodiments thereof, it can be modified, without departing from the scope and nature of the subject invention as defined in the appended claims.

What is claimed is:

1. A page for displaying inserts of various conventional sizes, said page comprising:
a backing sheet defining a peripheral edge;
a clear display sheet overlaying at least one side of the backing sheet, said clear display sheet being attached to the backing sheet about the peripheral edge and along predetermined attachment patterns, said clear display sheet having at least first and second openings; and
at least one horizontal row of pockets for receiving the inserts, said row of pockets being defined by the attachment patterns and the openings, wherein two adjacent pockets of a given row share one of said first and second openings, and wherein during use, a row of pockets may be used to display inserts which span at least two adjacent pockets in said row.

2. A page according to claim 1, wherein said openings consist of slits formed in the display sheet.

3. A page according to claim 1, wherein said backing sheet is made of a clear sheet material.

4. A page according to claim 1, wherein said backing sheet is made of a flexible opaque material.

5. A page according to claim 1 further comprising a second clear display sheet overlaying the other side of the backing sheet.

6. A page according to claim 1, wherein attachment patterns includes a generally horizontal seal line, said seal line defining upper and lower rows of pockets.

7. A page according to claim 1, wherein said backing sheet further includes a generally vertical fold line about said one of said first and second openings shared by two adjacent pockets of a given row of pockets.

8. A page according to claim 1, wherein said peripheral edge includes an album securement portion.

9. A page according to claim 8, wherein said album securement portion comprises album ring receiving apertures.

10. A page according to claim 1, wherein said page comprises a generally rectangular configuration.

11. A page according to claim 1, wherein the insert is a photograph.

12. A page for displaying inserts of various conventional sizes, said page comprising:
a backing sheet defining a peripheral edge, said backing sheet having at least first and second openings;
a clear display sheet overlaying the backing sheet, said clear display sheet being attached to the backing sheet about the peripheral edge and along predetermined attachment patterns; and
at least one horizontal row of pockets for receiving the inserts, said row of pockets being defined by the attachment patterns and the openings, wherein two adjacent pockets of a given row share one of said first and second openings, and wherein during use, a row of pockets may be used to display inserts which span at least two adjacent pockets in said row.

13. A photo album including an album page for displaying inserts of various conventional sizes, said album page comprising:
a backing sheet defining a peripheral edge, said peripheral edge including an album securement portion;
a clear display sheet overlaying at least one side of the backing sheet, said clear display sheet being attached to the backing sheet about the peripheral edge and along predetermined attachment patterns, said clear display sheet having at least first and second openings; and
at least one horizontal row of pockets for receiving the inserts, said row of pockets being defined by the attachment patterns and the openings, wherein two adjacent pockets of a given row share one of said first and second openings, and wherein during use, a row of pockets may be used to display inserts which span at least two adjacent pockets in said row.
